(19) United States
(12) Patent Application Publication
(10) Pub. No.: US 2024/0204230 A1
(43) Pub. Date: Jun. 20, 2024

(54) STACKING UNIT AND STACKING METHOD TO FORM A STACK OF ELECTROCHEMICAL CELLS OF AN ELECTRIC BATTERY

(71) Applicant: MANZ ITALY S.R.L., SASSO MARCONI (BO) (IT)

(72) Inventors: Pasqualino Alongi, SASSO MARCONI (BO) (IT); Massimiliano Sale, SASSO MARCONI (BO) (IT); Sergio Cirino, SASSO MARCONI (BO) (IT); Luca Zambonelli, SASSO MARCONI (BO) (IT)

(73) Assignee: MANZ ITALY S.R.L., SASSO MARCONI (BO) (IT)

(21) Appl. No.: 18/555,142

(22) PCT Filed: Apr. 14, 2022
(86) PCT No.: PCT/IB2022/053517

§ 371 Date: Oct. 12, 2023

(30) Foreign Application Priority Data
Apr. 16, 2021 (IT) 102021000009626

(51) Int. Cl. H01M 10/04

(52) U.S. Cl. CPC H01M 10/0404

(57) ABSTRACT

Stacking unit and stacking method for forming a stack of electrochemical cells of an electric battery. The following are provided: a forming container configured to receive in succession the single electrochemical cells which are arranged successively one on top of the other to form the stack; at least one gripping head configured to receive and retain an electrochemical cell; a drum which is rotatably mounted around a rotation axis for cyclically advancing the gripping head along a circularly shaped transfer path; a gripping station which is arranged along the transfer path and is configured to feed a single electrochemical cell to the gripping head; and a release station which is arranged along the transfer path downstream of the first gripping station and is configured to release, from the first gripping head a single electrochemical cell into the forming container.

### CROSS-REFERENCE TO RELATED APPLICATIONS

This patent application is related to Italian Patent Application No. 102021000009626 filed on Apr. 16, 2021, the entire disclosure of which is incorporated herein by reference.

### TECHNICAL FIELD OF THE INVENTION

The present invention relates to a stacking unit and to a stacking method for forming a stack of electrochemical cells of an electric battery.

### STATE OF THE ART

A parallelepipedal (planar) electric battery comprises a stack of electrochemical cells (i.e. of devices capable of converting electric energy into chemical energy or vice versa) superimposed one on top of the other.

Each electrochemical cell that is part of a stack is typically composed of four superimposed layers: a first layer which constitutes a cathode, a second layer which constitutes a separator, a third layer which constitutes an anode, and a fourth layer which constitutes a further separator (and thus similar to the second layer). In the stack all the electrochemical cells are identical to one another except the last cell (i.e. the terminal cell or the most external cell) which is placed last on top of the stack and which is shaped differently being devoid of the first layer which constitutes a cathode (i.e. the last cell is composed of only three superimposed layers: separator, anode and again separator).

Patent applications No. US20200185753A1 and No. EP2879223A1 describe some examples of a stacking unit for forming a stack of electrochemical cells of an electric battery.

### Subject and Summary of the Invention

The object of the present invention is to provide a stacking unit and a stacking method for forming a stack of electrochemical cells of an electric battery, said machine and said method allowing operating at a high operating speed (typically measured as number of stacks formed in the time unit) simultaneously ensuring a high working quality.

According to the present invention, a stacking unit and a stacking method for forming a stack of electrochemical cells of an electric battery are provided, according to what claimed in the appended claims.

The claims describe preferred embodiments of the present invention forming integral part of the present description.

### BRIEF DESCRIPTION OF THE DRAWINGS

The present invention will now be described with reference to the accompanying drawings, which illustrate a non-limiting example embodiment thereof, wherein:

FIG. 1 is a schematic and perspective view of a stack of electrochemical cells of an electric battery;

FIG. 2 is a schematic and cross-section view of an electrochemical cell of the stack of FIG. 1;

FIG. 3 is a schematic and cross-section view of a terminal (external) electrochemical cell of the stack of FIG. 1;

FIG. 4 is a schematic view, with details removed for clarity, of a stacking unit which is adapted to form the stack of FIG. 1 and is manufactured in accordance with the present invention;

FIG. 5 is a schematic view of a feeding drum of the stacking unit of FIG. 4; and

FIGS. 6 and 7 are two different schematic views of a transfer conveyor of the stacking unit of FIG. 4 with respective cam actuation systems in evidence.

### DETAILED DESCRIPTION OF PREFERRED EMBODIMENTS OF THE INVENTION

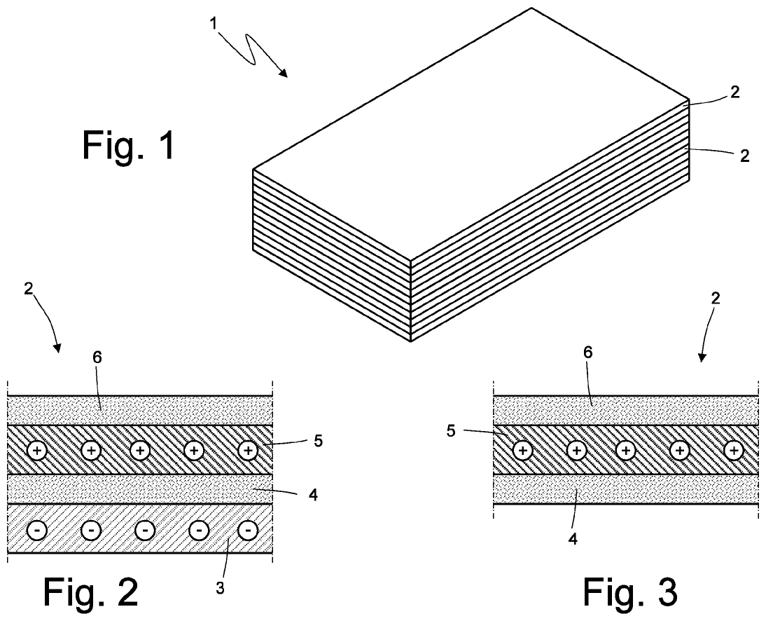

In FIG. 1, reference numeral 1 indicates, as a whole, a stack of electrochemical cells 2 (i.e. devices capable of converting electric energy into chemical energy and/or vice versa) of an electric battery.

In other words, the electric battery comprises the stack 1 of electrochemical cells 2 to which electric terminals and electronic control and management circuits are connected.

By way of example, a stack 1 can be composed of 25-35 (or more) electrochemical cells 2 superimposed one on top of the other. In particular, not limitedly, the electrochemical cells 2 can be of radial type (i.e. with the terminals arranged on a same side of the cell 2 and thus of the stack 1) or of axial type (i.e. with the terminals arranged on opposite sides of the cell 2 and thus of the stack 1).

According to what illustrated in FIGS. 2 and 3, each electrochemical cell 2 which is part of a stack 1 is typically composed of four layers 3-6 which are superimposed (as illustrated in FIG. 2): a first layer 3 which constitutes a cathode, a second layer 4 which constitutes a separator, a third layer 5 which constitutes an anode, and a fourth layer 6 which constitutes a further separator (and thus similar to the second layer 4). In the stack 1 all the electrochemical cells 2 are identical to one another except the last electrochemical cell 2 (i.e. the terminal electrochemical cell 2 or the most external electrochemical cell 2 illustrated in FIG. 3) which is placed last on top of the stack 1 and which is shaped differently being devoid of the first layer 3 which constitutes a cathode (i.e. the last electrochemical cell 2 is composed of only three layers 4, 5 and 6 which are superimposed: separator, anode and again separator).

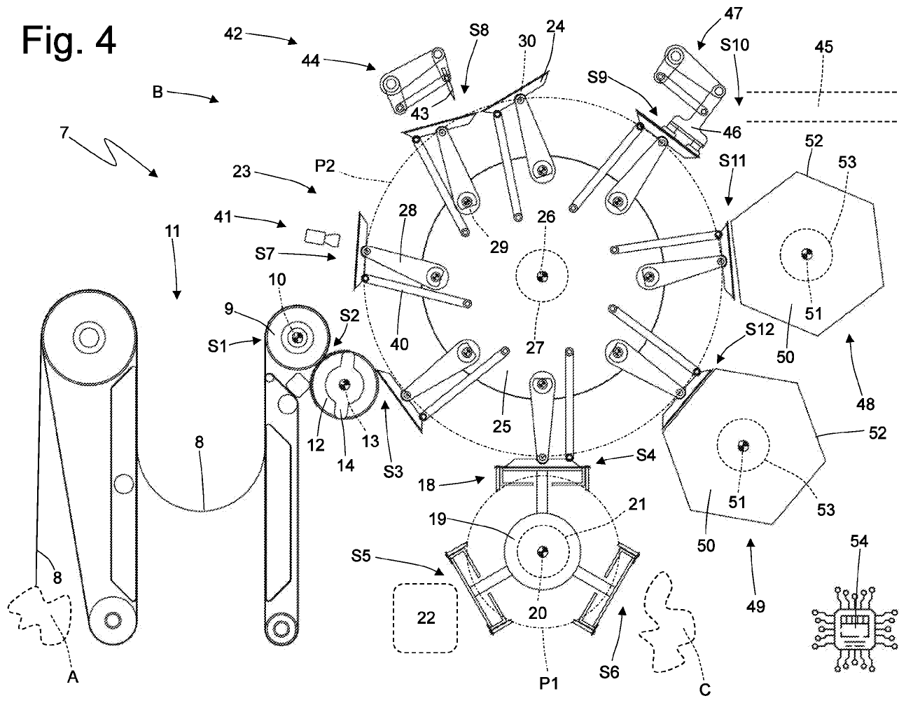

FIG. 4 illustrates, as a whole, a machine 7 for producing electric batteries each comprising a stack 1 of electrochemical cells 2.

The machine 7 comprises a production unit A (of known type and schematically illustrated) in which a continuous belt 8 of electrochemical cells 2 seamlessly arranged one after the other is produced; in the belt 8 both standard electrochemical cells 2 (i.e. provided with all four layers 3-6), and terminal or external electrochemical cells 2 (i.e. devoid of the layer 3 which constitutes a cathode) can be found since the production unit A is adapted to produce both (in order to produce a terminal electrochemical cell 2 it is sufficient to inhibit the feeding of the layer 3 which constitutes a cathode). Furthermore, the machine 7 comprises a stacking unit B which receives the belt 8 from the production unit A, transversally cuts the belt 8 for separating the single electrochemical cells 2 from the belt 8 (i.e. for “singularizing” the electrochemical cells 2), and then stacks the electrochemical cells 2 for forming the stacks 1.

Preferably, the continuous belt 8 of cells comprises a plurality of cells 2 (for example mono-cells, bi-cells or half-cells) whose separators, i.e. the second layer 4 and the fourth layer 6 are continuous.

In some non-limiting cases, also the layers 3 and 5, i.e. the electrodes, are continuous. In other non-limiting cases, the layers 3 and 5, i.e. respectively cathode and anode, are already discretized so that adjacent cells 2 on the continuous belt 8 (in which the continuity is given by the layers 4 and 6 of the separators and the cell 2 by the layers 3 and 5 which are superimposed in an aligned and alternated manner with the layers 4 and 6) are separated from one another by an intermediate space in which the sole separator layers 4 and 6 are superimposed.

In the latter case, the stacking unit B receiving the belt 8 from the production unit A transversally cuts the belt 8 at the abovementioned intermediate space so as to separate the single electrochemical cells 2 from the continuous belt 8.

Finally, the machine 7 comprises a working unit C (of known type and schematically illustrated) which receives the stacks 1 from the stacking unit B and performs final works on the stacks 1.

The stacking unit B comprises a feeding roller 9 which is rotatably mounted for rotating with a continuous law of motion (i.e. with a law of motion that provides for advancing at a constant speed without alternating motion phases and rest phases) around a rotation axis 10 which is horizontal and perpendicular to the plane of the sheet.

The feeding roller 9 receives the belt 8 at an input station S1 from the production unit A; preferably, upstream of the feeding roller 9 (i.e. between the feeding roller 9 and the production unit A) a compensating device 11 is arranged in which the belt 8 forms a loop having variable length for keeping a tension of the belt 8 constant.

The stacking unit B comprises a feeding roller 12 which is rotatably mounted for rotating with a continuous law of motion around a horizontal rotation axis 13, is arranged next to the feeding roller 9, and receives the belt 8 from the feeding roller 9 at a transfer station S2. The feeding roller 12 is coupled to a cutting device 14 (provided, in the illustrated embodiment, with two different cutters) which is configured to separate a single electrochemical cell 2 from the continuous belt 8; at the feeding roller 12, the continuous belt 8 is thus singularized and becomes a succession of single electrochemical cells 2 separate from one another. The single electrochemical cells 2 leave the feeding roller 12 at a gripping station S3, as it will be better described in the following.

The timing of the continuous belt 8 with respect to the cutting device 14 in order to ensure that the transverse cut of the belt 8 always occurs in the correct position is performed by means of optic sensors (typically cameras) which, by detecting the position of specific references, determine the exact position (step) of the continuous belt 8 and can thus consequently adjust the advancement of the continuous belt 8.

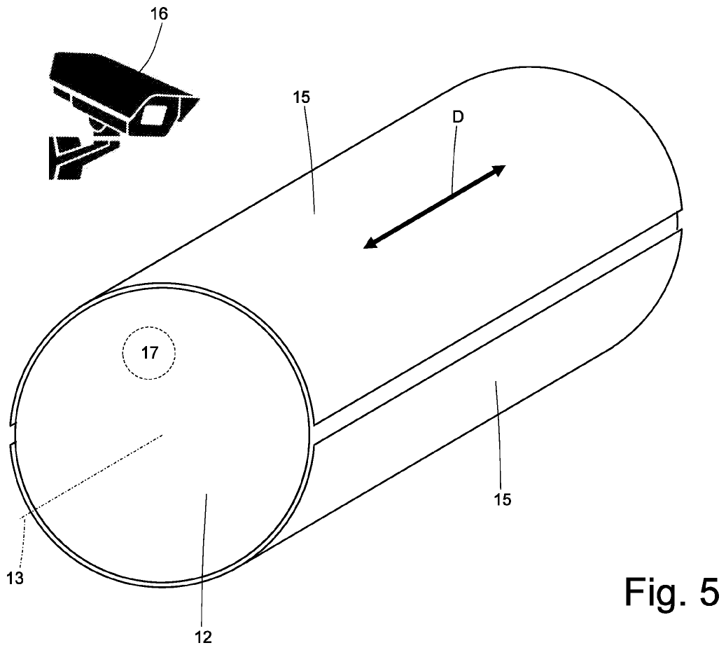

According to a preferred embodiment illustrated in FIG. 5, the feeding drum 12 comprises two suction seats 15, each of which is mounted on the feeding drum 12 so as to be movable with respect to the feeding drum 12, and is configured to retain a single electrochemical cell 2 (initially still connected to the rest of the continuous belt 8 and subsequently separated from the rest of the continuous belt 8 by a transverse cut performed by the cutting device 14). In particular, each suction seat 15 is movable with respect to the feeding drum 12 so as to move (with a maximum stroke limited in the order of millimeters) along an alignment direction D parallel to the rotation axis 13. The feeding drum 12 further comprises a sensor device 16 for detecting a position of the electrochemical cell 2 carried by a suction seat 15; i.e. the sensor device 16 allows verifying the correct alignment of the electrochemical cell 2 carried by a suction seat 15. Finally, the feeding drum 12 comprises an actuator device 17 (for example an electric stepper motor) which is configured to move each suction seat 15 with respect to the feeding drum 12 and along the alignment direction D depending on a detection performed by the sensor device 16 and to arrange (if necessary) the electrochemical cell 2 carried by the suction seat 15 in a desired position (i.e. to correctly align the electrochemical cell 2 correcting any position errors).

Preferably, the sensor device 16 comprises a camera which frames the periphery of the feeding drum 12 and thus optically detects the actual position of an electrochemical cell 2 carried by a suction seat 15; in this regard, on the outer surface of the suction seat 15, visible reference notches could be printed which define the desired position of the electrochemical cell 2 and provide the sensor device 16 with visible references for evaluating the correct positioning of the electrochemical cell 2.

In the embodiment illustrated in FIG. 5, each suction seat 15 is movable with respect to the drum 12 only along a single alignment direction D parallel to the rotation axis 13. According to a different embodiment, each suction seat 15 is movable with respect to the drum 12 also along a further circumferential alignment direction (i.e. perpendicular to the alignment direction D). According to a further embodiment, each suction seat 15 is movable with respect to the drum 12 also rotating around an alignment axis perpendicular to the alignment direction D (and thus perpendicular to the rotation axis 13).

According to what illustrated in FIG. 4, the stacking unit B comprises three forming containers 18 (but the overall number thereof could obviously be different), each of which is configured to receive in succession the single electrochemical cells 2 which are arranged successively one on top of the other for forming the stack 1 inside the forming container 18. In particular, each forming container 18 has the shape of a box which is open at one end (through which the single electrochemical cells 2 are progressively inserted in the forming container 18) and is delimited by a flat and movable bottom wall and by a rectangular and fixed side wall; as the single electrochemical cells 2 are inserted in a forming container 18, the bottom wall (which initially is in a completely lifted position) lowers increasing the internal volume of the forming container 18 and keeping always on the same plane the position in which to insert the following electrochemical cell 2.

The stacking unit B comprises a drum 19 which supports the three forming containers 18 and is rotatably mounted around a rotation axis 20 (parallel to the rotation axis 10 and thus horizontal) for moving each forming container 18 along a circularly shaped transfer path P1 which passes through a release station S4 in which each forming container 18 standing still in rest receives in succession the electrochemical cells 2. In particular, each forming container 18 is rigidly mounted on the drum 19 by means of a corresponding support arm devoid of hinges; consequently, each forming container 18 blindly follows the rotation movement of the drum 19 without ever carrying out any movement with respect to the drum 19. The drum 19 is brought into rotation around the rotation axis 20 by an actuator device 21 (normally a dedicated electric motor) with a step law of motion (i.e. a law of motion that provides for a cyclical alternation of motion phases and rest phases). The rotation of the drum 19 moves each forming container 18 along the transfer path P1 and through: the release station S4 (in which each forming container 18 standing still in rest receives in succession the electrochemical cells 2), through a fastening station S5 (in which a complete stack 1 is subjected to a fastening for clamping and stabilizing the stack 1) and finally through a transfer station S6 (in which a formed and fastened stack 1 leaves the corresponding forming container 18 towards the working unit C). In other words, the actuator device 21 moves each empty forming container 18 into the release station S4 and keeps the forming container 18 in the release station S4 until a completion of the stack 1 inside the forming container 18.

At the fastening station S5, a fastening device 22 is arranged which is configured to perform the fastening of a stack 1 carried by a forming container 18 standing still in rest in the fastening station S5.

The stacking unit B comprises a transfer conveyor 23 which supports and moves a plurality of gripping heads 24 (eight gripping heads 24 in the embodiment illustrated in the accompanying figures, but the number thereof could be different), each of which is adapted to receive and retain (typically by means of suction) a single electrochemical cell 2. The transfer conveyor 23 cyclically advances each gripping head 24 along a circular transfer path P2 which passes through the gripping station S3 (configured to feed a single electrochemical cell 2 to the gripping head 24) and which thus passes through the release station S4 (arranged along the transfer path P2 downstream of the gripping station S3 and configured to make the gripping head 24 release a single electrochemical cell 2 into the forming container 18 standing still in rest in the release station S4).

The transfer conveyor 23 comprises a drum 25 which is rotatably mounted around a rotation axis 26 (parallel to the rotation axis 10 and thus not vertical, preferably horizontal) and supports the gripping heads 24 for advancing the gripping heads 24 along the circularly shaped transfer path P2. Furthermore, the transfer conveyor 23 comprises an actuator device 27 (typically a dedicated electric motor) which brings the drum 25 into rotation around the rotation axis 26 with a continuous law of motion (i.e. with a law of motion which provides for advancing at a constant speed without alternating motion phases and rest phases).

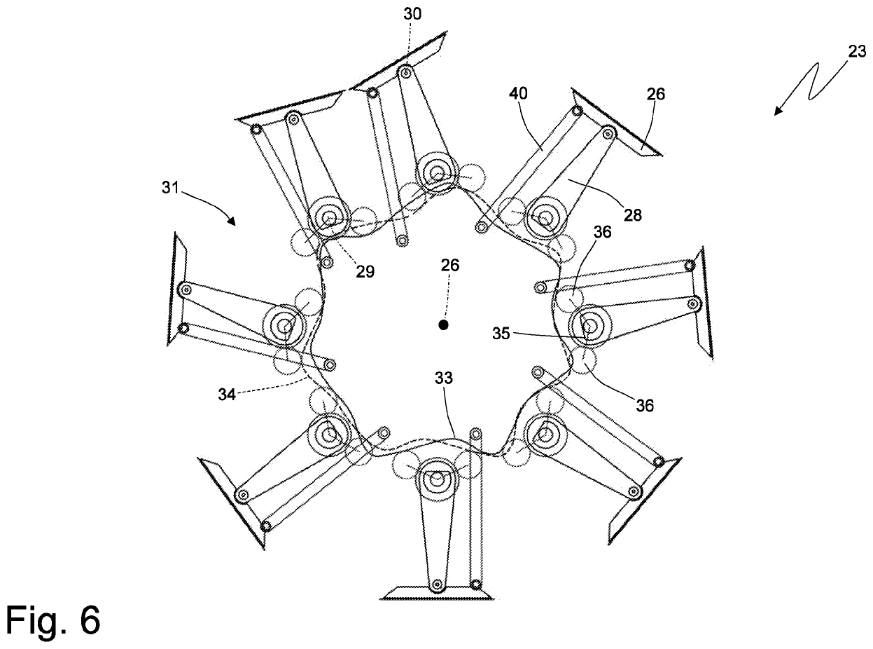

According to what better illustrated in FIGS. 5 and 6, the transfer conveyor 23 comprises a plurality of arms 28, each of which at an inner end is hinged to the drum 25 so as to rotate, with respect to the drum 25, around a rotation axis 29 parallel to the rotation axis 26 and at an outer end supports a corresponding gripping head 24 in a rotatable manner around a rotation axis 30 parallel to the rotation axis 29.

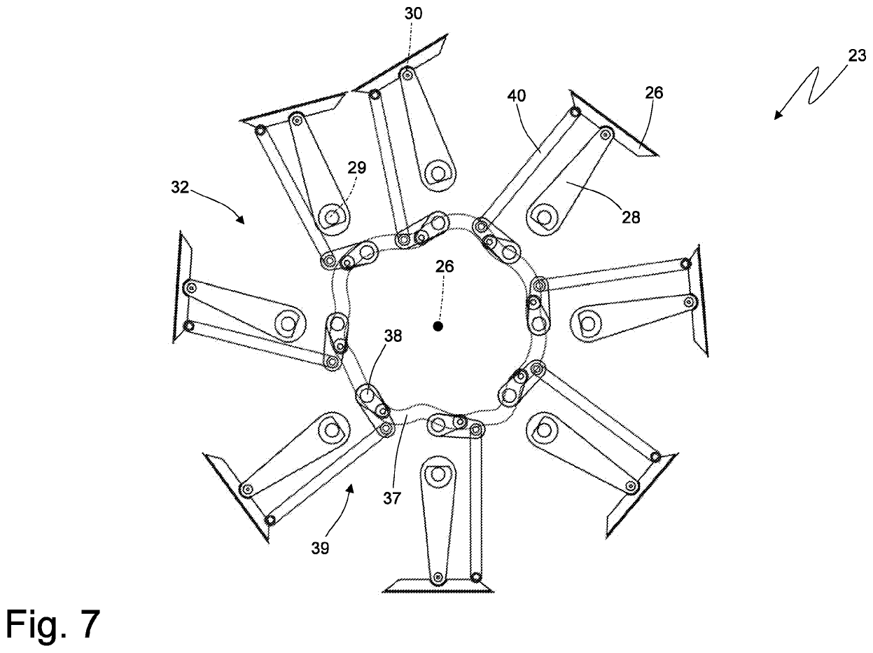

A cam actuation system 31 (illustrated in FIG. 6) is provided which drives the rotation of each arm 28 around the corresponding rotation axis 29 by exploiting the rotation movement of the drum 25 around the rotation axis 26. Similarly, a cam actuation system 32 (illustrated in FIG. 7) is provided which is separate from and independent of the cam actuation system 31 and drives the rotation of each gripping head 24 around the corresponding rotation axis 30 by exploiting the rotation movement of the drum 25 around the rotation axis 26.

According to what illustrated in FIG. 6, the cam actuation system 31 comprises two fixed cams 33 and 34 which are arranged around the rotation axis 26 and a series of trolleys 35, each of which is integral with a corresponding arm 28 and is provided with a pair of cam follower rollers 36 which couple to the respective fixed cams 33 and 34.

According to what illustrated in FIG. 7, the cam actuation system 32 comprises a fixed cam 37 arranged around the rotation axis 26, a plurality of cam follower rollers 38 which are coupled to the fixed cam 37, and a plurality of leverages 39, each of which transmits the motion from a corresponding cam follower roller 38 to a corresponding gripping head 24. In particular, each leverage 39 comprises, among the various components, a final arm 40 which is hinged to the corresponding gripping head 24 in an eccentric position with respect to the rotation axis 30.

According to what illustrated in FIG. 4, two control stations S7 and S8 are provided which are arranged one after the other along the transfer path P2 and are configured to control the compliance of an electrochemical cell 2 carried by a gripping head 24, i.e. to control t the electrochemical cell 2 meets the nominal specifications. The control station S7 comprises an optic control device 41 (normally comprising a camera) which performs an optic control of an electrochemical cell 2 carried by a gripping head 24. In the embodiment illustrated in the accompanying figures, the optic control device 41 acquires (at least) a digital image of the electrochemical cell 2 and such digital image is analyzed for determining the outward (visible) characteristics of the electrochemical cell 2.

The control station S8 comprises a control device 42 which performs an electric control of an electrochemical cell 2 carried by a gripping head 24; in particular, the control device 42 performs an electric resistivity (conductivity) measurement. In the embodiment illustrated in the accompanying figures, the optic control device 42 comprises (at least) a tip electrode 43 and an actuator device 44 which moves the tip electrode 43 between a passing position (illustrated in FIG. 4) in which the tip electrode 43 is relatively far from a gripping head 24 which transits through the control station S8 and an operating position (not illustrated) in which the tip electrode 43 is in contact with an electrochemical cell 2 carried by a gripping head 24 which transits through the control station S8. For example, the actuator device 44 comprises a five-bar linkage which at one end supports the tip electrode 43. The law of motion impressed by the actuator device 44 on the tip electrode 43 allows keeping, for a certain time, the tip electrode 43 coupled to an electrochemical cell 2 carried by a gripping head 24 which transits through the control station S8; contextually, the gripping head 24 that transits through the control station S8 is kept facing the tip by means of a combination of a rotation (driven by the cam actuation system 31) of the corresponding arm 28 around the rotation axis 29 and of a rotation (driven by the cam actuation system 32) of the gripping head 24 around the rotation axis 30.

A rejection station S9 is provided which is arranged along the transfer path P2 downstream of the control station S8 and is configured to pick up a faulty electrochemical cell 2 (i.e. recognized as faulty by the controls performed in the control stations S7 and S8) carried by a gripping head 24 for removing the faulty electrochemical cell 2 from the gripping head 24 and to send the faulty gripping head 24 towards an ejection conveyor 45 of the rejects. The rejection station S9 comprises a suction gripping head 46 adapted to receive and retain an electrochemical cell 2, and an actuator device 47 which supports the gripping head 46 and is configured to move the gripping head 46 between the rejection station S9 in which the gripping head 46 picks up an electrochemical cell 2 carried by a gripping head 24 which transits through the rejection station S9 and an ejection station S10 at an input of the ejection conveyor 45.

For example, the actuator device 47 comprises a deformable articulated quadrilateral which at one end supports the gripping head 46. The law of motion impressed by the actuator device 47 on the gripping head 46 allows keeping, for a certain time, the gripping head 46 coupled to an electrochemical cell 2 carried by a gripping head 24 which transits through the rejection station S9; contextually, the gripping head 24 that transits through the rejection station S9 is kept facing the gripping head 46 by means of a combination of a rotation (driven by the cam actuation system 31) of the corresponding arm 28 around the rotation axis 29 and of a rotation (driven by the cam actuation system 32) of the gripping head 24 around the rotation axis 30.

According to a preferred (but not binding) embodiment illustrated in FIG. 4, the stacking unit B comprises an exchange station S11 which is arranged along the transfer path P2 (downstream of the rejection station S9), and a storage unit 48 which is arranged at the exchange station S11 and is suitable for temporarily storing an electrochemical cell 2 in such a way that each gripping head 24 carrying an electrochemical cell 2 upon passing through the exchange station S11 may yield the electrochemical cell 2 to the storage unit 48 or each empty gripping head 24 upon passing through the exchange station S11 may pick up an electrochemical cell 2 from the storage unit 48.

According to a preferred (but not binding) embodiment illustrated in FIG. 4, the stacking unit B comprises an exchange station S12 which is arranged along the transfer path P2 (downstream of the exchange station S11), and a storage unit 49 which is arranged at the exchange station S12 and is adapted to temporarily store an (a terminal) electrochemical cell 2 in such a way that each gripping head 24 carrying a terminal electrochemical cell 2 upon passing through the exchange station S12 may yield the terminal electrochemical cell 2 to the storage unit 49 or each empty gripping head 24 upon passing through the exchange station S12 may pick up a terminal electrochemical cell 2 from the storage unit 49.

The two storage units 48 and 49 are structurally identical to one another and each one comprises a drum 50 which is rotatably mounted around a rotation axis 51 parallel to the rotation axis 26 and has a plurality of suction seats 52 which are uniformly distributed around the rotation axis 51 and are suitable for housing respective electrochemical cells 2; an actuator device 53 is provided which brings the drum 50 into rotation around the rotation axis 51 with a step law of motion for varying the suction seat 52 facing the exchange station S11. Preferably, each drum 50 has a polygonal (hexagonal in the non-limiting embodiment illustrated in the accompanying figures) cross-section in such a way that the side surface of the drum 50 is formed by a succession of flat walls each of which constitutes a corresponding suction seat 52. According to a different embodiment not illustrated, each drum 50 has a circular cross-section and consequently the suction seats 52 are no longer flat but have a cylindrical shape.

Finally, the machine 7 comprises a control unit 54 which superintends the operation of the entire machine 7 and thus the operation of the three units A, B and C which compose the machine 7.

In use, the storage unit 48 is always and only used for stocking standard electrochemical cells 2 (i.e. provided with all four layers 3-6), whereas the storage unit 49 is always and only used for stocking terminal or external electrochemical cells 2 (i.e. devoid of the layer 3 which constitutes a cathode).

In use, the production unit A is cyclically driven for producing a sequence of terminal or external electrochemical cells 2 (i.e. devoid of the layer 3 that constitutes a cathode) which are thus all stored in the storage unit 49 (obviously not more than six terminal or external electrochemical cells 2 since the storage unit 49 has at the most six suction seats 52 in the non-limiting embodiment illustrated in the accompanying figures); in other words, when necessary (typically every three-six stacks 1 produced), the production unit A is driven for producing a sequence of terminal or external electrochemical cells 2 which are all stocked in the storage unit 49.

In use, the storage unit 48 is normally kept half full (i.e. half empty) in such a way that it always has the possibility to both receive an electrochemical cell 2 from a gripping head 24 which passes through the exchange station S11, and yield an electrochemical cell 2 to a gripping head 24 which passes through the exchange station S11.

The modes with which the stacking unit B makes a stack 1 of electrochemical cells 2 in a forming container 18 initially empty and standing still in rest in the release station S4 are described in the following.

Initially, the drum 19 carries out a rotation step for moving an empty forming container 18 from the transfer station S6 (into which the forming container 18 has released a formed and fastened stack 1) to the release station S4.

Contextually, the drum 25 of the transfer conveyor 23 continues moving the gripping heads 24 along the transfer path P2 for cyclically passing through: the gripping station S3 in which the gripping heads 24 receive the standard and singularized (and possibly correctly aligned) electrochemical cells 2 from the feeding drum 12, the control stations S7 and S8 in which the standard electrochemical cells 2 are controlled, the rejection station S9 into which a possible faulty standard electrochemical cell 2 is rejected, through the exchange stations S11 and S12, and finally through the release station S4 in which the standard electrochemical cells 2 are released in succession inside the forming container 18 standing still in rest for forming the stack 1. When the stack 1 is almost complete, a gripping head 24 arrives empty at the exchange station 12 (either because it has not picked up a standard electrochemical cell 2 in the gripping station S3 or because it has yielded the standard electrochemical cell 2 to the storage unit 48 in the exchange station S11) so as to be able to receive in the exchange station 12 a terminal or external electrochemical cell 2 from the storage unit 49 and thus arrive at the gripping station with S3 the terminal or external electrochemical cell 2 which is released into the forming container 18 standing still in rest and thus complete the forming of a stack 1.

It is important to observe that a gripping head 24 can arrive empty at the exchange station 12 because it has not picked up a standard electrochemical cell 2 in the gripping station S3; obviously in this case the feeding drums 9 and 12 (which are located downstream of the gripping station S3) must be suitably slowed down (or also stopped for an instant) so as “to skip a turn”, i.e. prevent a standard electrochemical cell 2 that is not picked up by the gripping head 24 from arriving at the gripping station S3. Generally, it is sufficient to slow down only the feeding drums 9 and 12 (which are small and thus have a reduced inertia) since the compensating device 11 allows compensating the (temporary) speed difference between the production unit A and the feeding drums 9 and 12.

The storage unit 48 containing the standard electrochemical cells 2 allows decoupling what occurs in the gripping station S3 from what occurs downstream of the gripping station S3 and in particular in the rejection station S9; in this manner, regardless of whether or not a standard electrochemical cell 2 is found faulty and thus rejected into the rejection station S9, it is always possible to choose to have, downstream of the rejection station S9, an empty gripping head 24 (because it has left its standard electrochemical cell 2 at the storage unit 48) or a full gripping head 24 (because it has picked up a standard electrochemical cell 2 at the storage unit 48).

Similarly, the storage unit 49 containing the terminal or external electrochemical cells 2 allows decoupling what occurs in the gripping station S3 from what occurs downstream of the gripping station S3 and in particular in the rejection station S9; in this manner, regardless of whether or not a terminal or external electrochemical cell 2 is found faulty and thus rejected into the rejection station S9, it is always possible to have, downstream of the rejection station S9, a gripping head 24 containing a terminal or external electrochemical cell 2 at the right moment (i.e. for completing a stack 1 being formed in the forming container 18); in fact, it is always possible to free (to empty) a gripping head 24 leaving the standard electrochemical cell 2 initially carried by the gripping head 24 in the storage unit 48 and thus immediately after make the gripping head 24 pick up a terminal or external electrochemical cell 2 from the storage unit 49.

Substantially, thanks to the presence of the storage unit 49, it is no longer necessary to form a single terminal or external electrochemical cell 2 in the assumed correct position with the risk that an unpredicted and unpredictable (and totally random) rejection of standard electrochemical cells 2 or of the terminal or external electrochemical cell 2 does not make a terminal or external electrochemical cell 2 arrive in the gripping station S3 at the right moment (i.e. when it is necessary “to close” an almost complete stack 1); in fact, thanks to the presence of the storage unit 49, it is possible to decouple the production of the terminal or external electrochemical cells 2 from the forming of the stacks 1, i.e. it is possible to dedicate temporal windows to the production of an array of terminal or external electrochemical cells 2 which are temporarily stocked in the storage unit 49 for being used one at a time when necessary and exactly when necessary.

In other words, in order to make the stacks 1 of electrochemical cells 2 the gripping heads 24 are cyclically advanced along the transfer path P2 for receiving in the gripping station S3 single electrochemical cells 2 and subsequently for releasing the single electrochemical cells 2 into a forming container 18 standing still in rest in the release station S4. Each stack 1 is composed of a plurality of standard electrochemical cells 2 and of a single terminal electrochemical cell 2 which is arranged last on top of the stack 1 and concludes the formation of the stack 1; in the storage unit 49 a series of terminal electrochemical cells 2 are thus previously stored and, when the stack 1 being formed in the forming container 18 has received all the standard electrochemical cells 2, the gripping head 24 advances empty through the exchange station S12 for receiving from the storage unit 49 a terminal electrochemical cell 2 (in a “just in time” manner) which is released immediately after into the forming container 18 standing still in rest in the release station S4.

Consequently, a series of terminal electrochemical cells 2 are produced, periodically and together (i.e. one after the other), said series of terminal electrochemical cells 2 advancing all together (i.e. one after the other) towards the gripping station S3 for being picked up by the gripping heads 24 and then released into the storage unit 49 (in this manner the storage unit 49 is filled with terminal electrochemical cells 2 to be subsequently used one at a time in view of the forming of future stacks 1). A series of standard electrochemical cells 2 sufficient for the production of several stacks 1 are thus produced without interruption since in order to complete each stack 1 a corresponding terminal electrochemical cell 2 stored in the storage unit 49 (i.e. previously prepared for being in the right place at the right time) is used. Consequently, a number of standard electrochemical cells 2 is produced without interruption, said number being substantially an integer multiple of the number of terminal electrochemical cells 2 stored in the storage unit 49. Actually, the number of standard electrochemical cells 2 produced is slightly increased with respect to the exact integer multiple of the number of terminal electrochemical cells 2 stored in the storage unit 49 for keeping into account possible rejections (by using an average of rejections); if during the stacking it is observed that the number of rejections is different from what envisaged (i.e. different from the average) it is possible to reprogram the number of standard electrochemical cells 2 to be produced and/or the storage unit 48 can be used for storing exceeding standard electrochemical cells 2 or for receiving lacking standard electrochemical cells 2.

As mentioned in the foregoing, it is possible to store in the storage unit 48 a standard electrochemical cell 2 carried by a gripping head 24 for making the gripping head 24 empty when a terminal electrochemical cell 2 has to be released into the release station S4; i.e. the gripping head 24 is emptied from the standard electrochemical cell 2 in the storage unit 48 for allowing the empty gripping head 24 to pick up immediately after a terminal electrochemical cell 2 from the storage unit 49.

Obviously, from time to time, a standard electrochemical cell 2 is picked up from the storage unit 48 so as to prevent the complete filling of the storage unit 48 advancing an empty gripping head 24 through the exchange station S11 (associated with the storage unit 48). A gripping head 24 is advanced empty through the exchange station S11 because a standard electrochemical cell 2 picked up by the gripping head 24 in the gripping station S3 has been rejected upstream of the exchange station S11; alternatively a gripping head 24 is advanced empty through the exchange station S11 because the gripping head 24 has not received any standard electrochemical cell 2 in the gripping station S3 (for example because the feeding assembly arranged upstream of the gripping station S3 has been slowed down so as to prevent the gripping head 24 from receiving any standard electrochemical cell 2 in the gripping station S3).

According to a different embodiment not illustrated, the storage unit 48 is absent and only the storage unit 49 is thus present which is used always and only for stocking terminal or external electrochemical cells 2 (i.e. devoid of the layer 3 that constitutes a cathode), or for stocking both standard electrochemical cells 2 (i.e. provided with all four layers 3-6), and terminal or external electrochemical cells 2 (i.e. devoid of the layer 3 that constitutes a cathode). According to a further embodiment not illustrated, both storage units 48 and 49 are absent.

It is important to observe that along the entire transfer path P2, each gripping head 24 continuously carries out a series of movements with respect to the drum 25 which are due to a combination of a rotation around the rotation axis 29 (driven by the cam actuation system 31) and of a simultaneous rotation around the rotation axis 30 (driven by the cam actuation system 32); these movements of each gripping head 24 with respect to the drum 25 allow the gripping head 24 to interact in the stations S3, S7, S8, S9, S11, S12 and S4 with optimum modes also operating at high speed; for example, before approaching a station S3, S7, S8, S9, S11, S12 or S4, the arm 28 of a gripping head 24 can rotate around the corresponding rotation axis 29 for anticipating the advancement movement of the drum 25 (i.e. in the same rotation direction of the drum 25) and thus in the station S3, S7, S8, S9, S11, S12 or S4 the arm 28 can rotate in opposite direction (i.e. opposite the rotation direction of the drum 25) for keeping (for a brief period) the gripping head 24 still or almost still.

The embodiments described herein can be combined with one another without departing from the scope of protection of the present invention.

The above-described stacking unit B has numerous advantages.

Firstly, the above-described stacking unit B allows operating at a high operating speed (typically measured as number of stacks 1 formed in the time unit) especially thanks to the continuous law of motion of the transfer conveyor 23.

Furthermore, the above-described stacking unit B allows ensuring a high working quality assuring both an accurate compliance control of each single electrochemical cell 2, and a very precise positioning of each single electrochemical cell 2 in a forming container 18 at the moment of making a stack 1.

Finally, the above-described stacking unit B allows rejecting all and only the faulty electrochemical cells 2, i.e. allows always using all the electrochemical cells 2 compliant with the specifications annulling the rejection of electrochemical cells 2 compliant with the specifications; this result is obtained thanks to the presence of the storage units 48 and 49 which allow decoupling the forming act of the stacks 1 from the production act of the electrochemical cells 2 thus having the possibility of compensating the unpredicted and unpredictable (and totally random) presence of faulty electrochemical cells 2 to be rejected.

### LIST OF THE REFERENCE NUMERALS OF THE FIGURES

1 stack
2 electrochemical cell
3 layer
4 layer
5 layer
6 layer
7 machine
8 belt
9 feeding roller
10 rotation axis
11 compensating device
12 feeding roller
13 rotation axis
14 cutting device
15 suction seat
16 sensor device
17 actuator device
18 forming container
19 drum
20 rotation axis
21 actuator device
22 fastening device
23 transfer conveyor
24 gripping head
25 drum
26 rotation axis
27 actuator device
28 arm
29 rotation axis
30 rotation axis
31 cam actuation system
32 cam actuation system
33 fixed cam
34 fixed cam
35 trolleys
36 cam follower roller
37 fixed cam
38 cam follower roller
39 leverage
40 arm
41 control device
42 control device
43 tip electrode
44 actuator device
45 ejection conveyor
46 gripping head
47 actuator device
48 storage unit
49 storage unit
50 drum
51 rotation axis
52 suction seats
53 actuator device
54 control unit
A production unit
B stacking unit
C working unit
S1 input station
S2 transfer station
S3 gripping station
S4 release station
S5 fastening station
S6 transfer station
S7 control station
S8 control station
S9 rejection station
S10 ejection station
S11 exchange station
S12 exchange station
D alignment direction
P1 transfer path
P2 transfer path

1. A stacking unit for forming a stack (1) of electrochemical cells (2) of an electric battery; the stacking unit comprising:
a forming container (18) configured to receive in succession the single electrochemical cells (2) which are arranged successively one on top of the other to form the stack (1);
at least one first gripping head (24) configured to receive and retain an electrochemical cell (2);
a transfer conveyor (23) supporting the first gripping head (24) for cyclically advancing the first gripping head (24) along a first transfer path (P2);
a gripping station (S3), which is arranged along the first transfer path (P2) and is configured to feed a single electrochemical cell (2) to the first gripping head (24); and
a release station (S4), which is arranged along the first transfer path (P2) downstream of the first gripping station (S3) and is configured to release, from the first gripping head (24) a single electrochemical cell (2) into the forming container (18);
the stacking unit is characterised in that the transfer conveyor (23) comprises a first drum (25) which is rotatably mounted around a non-vertical first rotation axis (26) so as to move the first gripping head (24) along the first circularly shaped transfer path (P2).

2. Stacking unit according to claim 1 and comprising a first actuator device (27) that brings the first drum (25) into rotation around the first rotation axis (26) with a continuous law of motion.

3. Stacking unit according to claim 1, wherein the transfer conveyor (23) comprises:
a first arm (28) which at an inner end is hinged to the first drum (25) to rotate, with respect to the first drum (25), around a second rotation axis (29) parallel to the first rotation axis (26) and at an outer end supports the first gripping head (24); and
a first cam actuation system (31) that drives the rotation of the first arm (28) around the second rotation axis (29) by exploiting the rotation movement of the first drum (25) around the first rotation axis (26).

4. Stacking unit according to claim 3, wherein:
the first gripping head (24) is hinged to the first arm (28) to rotate, with respect to the first arm (28), around a third rotation axis (30) parallel to the second rotation axis (29); and
a second cam actuation system (32) is provided which is separate from and independent of the first cam actuation system (31) and controls the rotation of the first gripping head (24) around the third rotation axis (30) by exploiting the rotation movement of the first drum (25) around the first rotation axis (26).

5. Stacking unit according to claim 4, wherein the second cam actuation system (32) comprises a second arm (40) which is hinged to the first gripping head (24) in an eccentric position with respect to the third rotation axis (30).

6. Stacking unit according to claim 1 and comprising:
at least one control station (S7, S8) which is arranged along the first transfer path (P2) and is configured to control the compliance of an electrochemical cell (2) carried by the first gripping head (24); and
a rejection station (S9) which is arranged along the first transfer path (P2) downstream of the control station (S7, S8) and is configured to pick up an electrochemical cell (2) carried by the first gripping head (24).

7. Stacking unit according to claim 6 and comprising:
a second gripping head (46) which is arranged at the rejection station (S9) and is adapted to receive and retain an electrochemical cell (2); and
a second actuator device (47) that supports the second gripping head (46) and is configured to move the second gripping head (46) between the rejection station (S9) at which the second gripping head (46) picks up an electrochemical cell (2) carried by the first gripping head (24) and an ejection station (S10).

8. Stacking unit according to claim 1 and comprising:
a first exchange station (S11) which is arranged along the first transfer path (P2); and
a first storage unit (48) which is arranged at the first exchange station (S11) and is suitable for temporarily storing an electrochemical cell (2) in such a way that the first gripping head (24) carrying an electrochemical cell (2) upon passing through the first exchange station (S11) may yield the electrochemical cell (2) to the first storage unit (48) or the first empty gripping head (24) upon passing through the first exchange station (S11) may pick up an electrochemical cell (2) from the first storage unit (48).

9. Stacking unit according to claim 8, wherein the first storage unit (48) comprises:
a second drum (50) which is rotatably mounted around a fourth rotation axis (51) parallel to the first rotation axis (26) and has a plurality of first suction seats (52) which are uniformly distributed around the fourth rotation axis (51) and are suitable for housing respective electrochemical cells (2); and
a third actuator device (53) which brings the second drum (50) into rotation around the fourth rotation axis (51) with a step law of motion to vary the first suction seat (52) facing the first exchange station (S11).

10. Stacking unit according to claim 8 and comprising:
a second exchange station (S12) which is arranged along the first transfer path (P2) downstream of the first exchange station (S11); and
a second storage unit (49) which is arranged at the second exchange station (S12) and is preferably identical to the first storage unit (48).

11. Stacking unit according to claim 10, wherein the first storage unit (48) is used to store standard electrochemical cells (2) and the second storage unit (49) is used to store terminal electrochemical cells (2) to be arranged on top of a stack (1) to close the stack (1).

12. Stacking unit according to claim 1 and comprising a third drum (19) supporting the forming container (18) and rotatably mounted around a fifth rotation axis (20) to move the forming container (18) along a second circularly shaped transfer path (P1) passing through the release station (S4).

13. Stacking unit according to claim 12 and comprising a fourth actuator device (21) that brings the third drum (19) into rotation around the fourth rotation axis (51) with a step law of motion to move an empty forming container (18) into the release station (S4) and keep the forming container (18) in the release station (S4) until a completion of the stack (1) inside the forming container (18).

14. Stacking unit according to claim 1 and comprising a first feeding drum (12) which is rotatably mounted around a fifth rotation axis (20) parallel to the first rotation axis (26) and advances an electrochemical cell (2) through the gripping station (S3) to yield the electrochemical cell (2) to the first gripping head (24).

15. Stacking unit according to claim 14, wherein the first feeding drum (12) comprises:
at least one second suction seat (15) which is mounted on the first feeding drum (12) to be movable, in particular at least parallel to the fifth rotation axis (20), with respect to the first feeding drum (12), and is configured to retain a single electrochemical cell (2);
a sensor device (16) for detecting a position of the electrochemical cell (2) carried by the second suction seat (15); and
a fifth actuator device (17), which is configured to move the second suction seat (15) with respect to the first feeding drum (12) according to a detection performed by the sensor device (16) and to arrange the electrochemical cell (2) carried by the second suction seat (15) in a desired position.

16. Stacking unit according to claim 14 and comprising a second feeding drum (9) which is rotatably mounted around a sixth rotation axis (10) parallel to the first rotation axis (26) and advances an electrochemical cell (2) towards the first feeding drum (12).

17. Stacking unit according to claim 14, and comprising a cutting device (14) which is coupled to the first feeding drum (12) and is configured to separate a single electrochemical cell (2) from a continuous belt (8) of electrochemical cells (2).

18. Stacking method for forming a stack (1) of electrochemical cells (2) of an electric battery; the stacking method comprises the steps of:
cyclically advancing at least a first gripping head (24) configured to receive and retain an electrochemical cell (2) along a first transfer path (P2) by means of a transfer conveyor (23);
feeding, at a gripping station (S3) which is arranged along the first transfer path (P2), a single electrochemical cell (2) to the first gripping head (24); and
releasing, at a release station (S4) which is arranged along the first transfer path (P2) downstream of the first gripping station (S3), from the first gripping head (24) a single electrochemical cell (2) into a forming container (18) configured to receive in succession the single electrochemical cells (2) which are arranged successively one on top of the other to form the stack (1);
the stacking method is characterised in that the transfer conveyor (23) comprises a first drum (25) which is rotatably mounted around a first rotation axis (26) to move the first gripping head (24) along the first circularly shaped transfer path (P2).
